(19) United States
(12) Patent Application Publication
(10) Pub. No.: US 2025/0004552 A1
(43) Pub. Date: Jan. 2, 2025

(54) METHOD, COMPUTER PROGRAM, AND DEVICE FOR TESTING THE INSTALLATION OR REMOVAL OF AT LEAST ONE COMPONENT

(71) Applicant: Volkswagen Aktiengesellschaft, Wolfsburg (DE)

(72) Inventors: Kevin Thiel, Berlin (DE); Christian Buzga, Braunschweig (DE); Denny Hecht, Eilsleben (DE); Maximilian Tegetmeier, Berlin (DE); Julia Peters, Hannover (DE); Falko Tubbe, Braunschweig (DE); Florian Peppel, Braunschweig (DE)

(21) Appl. No.: 18/710,583

(22) PCT Filed: Nov. 9, 2022
(86) PCT No.: PCT/EP2022/081354

§ 371 Date: May 15, 2024

(30) Foreign Application Priority Data
Nov. 17, 2021 (DE) 102021212928.5

(51) Int. Cl. G06F 3/01; G06T 19/00

(52) U.S. Cl. CPC G06F 3/014; G06T 19/006; G06T 2219/2008

(57) ABSTRACT

A method, computer program, and device for testing the installation or removal of at least one component within an installation environment, comprising real and virtual elements. A component, installation environment, installer's hand, and a mixed reality system worn by the installer may be calibrated. During an installation or removal attempt, the component, installer's hand, and mixed reality system are tracked. Collisions or near-collisions between the component, installer's hand, tool, and the real and virtual elements, as well as among components, are detected. Obstructions are identified. The installation or removal attempt is visualized via the mixed reality system. Additionally, the installation or removal path and information on collisions or near-collisions are displayed.

### RELATED APPLICATIONS

The present application claims priority to International Patent Application No. PCT/EP2022/081354 to Thiel et al., filed Nov. 9, 2022, titled “Method, Computer Program, And Device For Testing The Installation Or Removal Of At Least One Component,” which claims priority to German Pat. App. No. DE 10 2021 212 928.5, filed Nov. 17, 2021, to Thiel et al., the contents of each being incorporated by reference in their entirety herein.

### TECHNICAL FIELD

The present disclosure relates to technologies and techniques for testing an installation or a removal of at least one component into or from an installation environment. The installation environment may include real elements and virtual elements.

### BACKGROUND

During the development of a means of transportation, for example a motor vehicle, the buildability of the vehicle is continuously checked and optimized. Hardware models are often used for this purpose. The hardware models are regularly area models which only simulate a selected area of the means of transportation. These area models are built with 3D-printed components, components produced by means of milling or turning, as well as components made of prototypes and from series production. For the 3D printing, conventional methods such as selective laser sintering, selective laser melting, multi-jet modeling, or fused deposition modeling can be employed.

The use of area models has the advantage that the processes can be realistically tested and evaluated, and thereby are very meaningful. In particular, it is also possible to examine the achievability of certain elements and the forces to be applied by an installer. However, high costs arise for component procurement and installation. Moreover, long lead times are needed for the procurement or printing of components. Furthermore, it is possible that the hardware version mapped after printing or procurement possibly no longer reflects the current status.

For the purpose of training installers, virtual reality applications are increasingly employed. For example, WO 2014/037127 A1 describes a system for simulating an operation of a non-medical tool. The system comprises a device for detecting the spatial position and movement of a user, a data processing device, and a display device. The display device displays a virtual processing object. The data of the device for detecting the spatial position and movement of a user is sent to the data processing device, processed there and forwarded to the display device, which displays an image of the user or part of the user and an image of the tool. The positions and movements of the images are displayed based on the data of the devices for detecting the spatial position and movement of a user relative to the virtual processing object.

EP 3 066 656 B1 describes a virtual welding station for training an operator in the production of complete assemblies. The virtual welding station comprises a virtual sequencer for simulating different welding techniques and other processes.

Virtual reality applications can also be utilized to virtually check the buildability of a system. This has the advantage that experiments can be reconstructed cost-effectively and quickly. For certain problematic issues, however, arriving at a decision is a difficult process. In particular, for example, force expenditures to be applied, weights, or the sensation of friction during assembly cannot be virtually mapped.

### SUMMARY

Aspects of the present disclosure are directed to providing improved solutions for testing an installation or a removal of at least one component.

Some aspects of the present disclosure are provided in the subject matters of the independent claims, found below. Other aspects are disclosed in the subject matter of the respectively associated dependent claims, the description and the figures.

In some examples, a method is disclosed for testing an installation or a removal of at least one component into or from an installation environment that has real elements and virtual elements, comprising surveying the at least one component, the installation environment together with the real elements, at least one hand of an installer, and a mixed reality system worn by the installer; tracking the at least one component, the hand of the installer, and the mixed reality system during an attempted installation or removal of the at least one component; and visualizing the attempted installation or removal of the at least one component for the installer by the mixed reality system.

In some examples, a computer program is disclosed, including instructions that, when being executed by a computer, prompt the computer to carry out testing an installation or a removal of at least one component into or from an installation environment that has real elements and virtual elements, comprising: surveying the at least one component, the installation environment together with the real elements, at least one hand of an installer, and a mixed reality system worn by the installer; tracking the at least one component, the hand of the installer, and the mixed reality system during an attempted installation or removal of the at least one component; and visualizing the attempted installation or removal of the at least one component for the installer by the mixed reality system.

The term ‘computer’ as used herein shall be understood broadly. In particular, the term also encompasses workstations, distributed systems, and other processor-based data processing devices.

The computer program can, for example, be provided for electronic retrieval or be stored on a computer-readable memory medium.

In some examples, a device is disclosed for testing an installation or a removal of at least one component into or from an installation environment that has real elements and virtual elements, the device comprising: a surveying module for surveying the at least one component, the installation environment together with the real elements, at least one hand of an installer, and a mixed reality system worn by the installer; a tracking module for tracking the at least one component, the hand of the installer, and the mixed reality system during an attempted installation or removal of the at least one component; and a visualization module for visualizing the attempted installation or removal of the at least one component for the installer by the mixed reality system.

### DESCRIPTION OF THE DRAWINGS

Further features of the present disclosure can be derived from the following description and the accompanying claims, in conjunction with the figures.

FIG. 1 schematically shows a method for testing an installation or a removal of at least one component into or from an installation environment, according to some aspects of the present disclosure;

FIG. 2 shows a first embodiment of a device for testing an installation or a removal of at least one component into or from an installation environment, according to some aspects of the present disclosure;

FIG. 3 shows a second embodiment of a device for testing an installation or a removal of at least one component into or from an installation environment, according to some aspects of the present disclosure;

FIG. 4 schematically shows an installation or a removal of at least one component into or from an installation environment, according to some aspects of the present disclosure;

FIG. 5 schematically shows a component having markers arranged thereon, according to some aspects of the present disclosure;

FIG. 6 schematically shows a system diagram of a solution according to some aspects of the present disclosure; and

FIG. 7 shows a collision between two objects, according to some aspects of the present disclosure.

### DETAILED DESCRIPTION

To provide a better understanding of the principles of the present disclosure, examples and embodiments will be described hereafter in greater detail based on the figures. It shall be understood that the present disclosure is not limited to these embodiments, and that the described features can also be combined or modified, without departing from the scope of protection of the present disclosure, as it is defined in the accompanying claims.

Examples of the present disclosure may use an installation environment that combines real elements with virtual elements, visualized for the installer through mixed reality. In particular, augmented reality technologies can be used. Users perceive the superposition of virtual components on a real environment as more natural than using virtual reality. Additionally, the actual installation or removal process can be realistically reenacted since physical properties, such as friction and weight, are also simulated. Various installation space simulations can be viewed and compared immediately without alteration. The accuracy of superposing virtual and real environments is crucial for assessing potential installation examinations, so all objects involved are surveyed with high precision and tracked. Camera-based systems can be used for tracking. For example, the installation environment, along with the real elements, can be surveyed through contact or by attaching measuring points. Alternatively, the installation environment, along with the real elements, can be positioned in a known pose. Since the production of the real objects is based on computer-aided design (CAD) data, reference coordinates can be derived from this data and considered in the surveying process.

Depending on the complexity of the installation environment, concealments can be a major problem, such as concealments by components, the environment, or the user's body or hands. It may be helpful for the tracking sensors to include additional elements integrated into the installation environment. Tracking may also be implemented through a combination of outside-in tracking and inside-out tracking, a sensor fusion of two systems. The outside perspective during outside-in tracking provides a larger field of view but can be limited by the user. The inside-out tracking perspective, while having a smaller field of view, can be useful when the outside perspective is not available.

In some examples, the position and orientation of at least one component, the installer's hand, and the mixed reality system are detected and recorded. This ensures a correct positional arrangement of the virtual and real environments at all times. Recording the position and orientation allows the installation or removal process to be evaluated and viewed later. This can be done through visual reproductions of the installation or removal, or through diagrams and documents containing screenshots of such reproductions.

In some examples, at least one tool is surveyed and tracked. This helps recognize problems that may occur when a tool is used during the installation of at least one component.

In some examples, tracking is based on detecting passive or active markers, or three-dimensional tracking elements, arranged on or in the components, the mixed reality system, a tool, or the installer's hand. Markers or three-dimensional tracking elements are configured to be easily detected by the tracking device. For instance, passive markers can be adhesive elements attached to suitable points on the object. Active markers, such as infrared light-emitting diodes, can be incorporated into the object or applied together with an energy supply system. Three-dimensional tracking elements can be specially shaped parts integrated into the object or fastened to it, for example, by screwing them to existing or designated screw points. The pose of each element in relation to the object must be known, preferably achieved by surveying. Surveying components during movement from various directions is preferred. Alternatively, a measuring sensor can be used. The installation environment and the real elements can also be appropriately surveyed. When tracking elements are attached in known positions and poses, surveying may be unnecessary.

In some examples, the installer's hand is surveyed, including a glove worn by the installer and the fingers in relation to the glove. Gloves suitable for tracking are often one size fits all and intended for virtual reality applications. Trackers on the back of the hand and wrist ascertain the hand's general location. The inertial measuring units in the fingers are static relative to this tracker. Alternatively, fingers can be tracked optically using static points, similar to the back of the hand or wrist. Differently sized hands or ways of wearing the glove can cause discrepancies in fingertip positions. Surveying is advantageous in these cases. The survey can be conducted simultaneously for all five fingers at five known points, or sequentially for each finger at one known point. By placing fingertips on known points and tracking the hand with the glove's tracker, the relation between the fingers and the tracker can be determined. The hand model can be adapted accordingly. Alternatively, the tracker's assumed pose in relation to the hand can be corrected. Precise surveying of fingers in relation to the hand is crucial for mixed or augmented reality since users can directly perceive errors. This is not the case with virtual reality, where no relation with real objects exists, and the entire system can be slightly mispositioned.

In some examples, collisions or near-collisions between a component, the installer's hand, or a tool, and the real and virtual elements of the installation environment, as well as among the components, are detected during installation or removal attempts. Collisions or near-collisions can occur between real objects, virtual objects, and real and virtual objects. The respective intensity of the collision can also be detected. For example, detecting and optionally recording the speeds of the involved objects can indicate collision intensity. Visualizing collisions or near-collisions for the installer or an observer can be done by showing the intersection of the involved objects. Detecting and visualizing collisions or near-collisions in real time helps recognize problems during installation or removal.

In some examples, virtual representations of real objects are used to detect or visualize collisions or near-collisions. During installation or removal attempts, the pose of each object is known virtually. Virtual object representations can then be used to detect collisions or near-collisions easily. Approximated surfaces, such as surface distance matrices, can be used for this purpose. Virtual representatives do not need to be exact representations of the real objects. Deviating real objects, such as older versions or 3D-printed simpler objects, can be used as long as they have been surveyed and the deviating shape is irrelevant, for example, because the weight does not change. Using a similar component, even if not intended for installation in that shape, can be sufficient to check whether the installation is affected by the weight.

In some examples, tactile, auditory, or visual feedback is provided to the installer in response to a collision or near-collision with a virtual element. The component itself only provides force reactions when colliding with a real object. However, since virtual objects are present, collisions or near-collisions with them can be critical due to potential damage or injuries. Tactile feedback can be conveyed by vibration motors arranged on a glove worn by the installer. These motors convey collisions or near-collisions indirectly to the hands. Alternatively, vibration motors can be arranged in the components and included during their production. Another option is to convey a force reaction using a robot to realistically simulate collisions. The component is held by a robot arm, with the installer guiding it while it remains attached to the robot, which can exert counterforces. This approach suits predominantly virtual installation spaces. Auditory feedback can be conveyed via headphones worn by the installer, for example, as an audio warning. Visual feedback can be provided by a light-emitting diode on the component or through the mixed reality system.

In some examples, collisions or near-collisions outside the installer's visual range are visualized through a notice in the field of view. For example, an arrow or superimposed diagrams at the edge of a monitor can draw the installer's attention to these events. Auditory or haptic notices can also be used.

In some examples, virtual representatives of real objects are used to ascertain concealments during the visualization of installation attempts. Combining real and virtual objects in one scene can cause desired concealments to be inaccurately mapped. Using virtual objects as representatives of real objects allows control over which objects conceal others. This control enhances the realism of the visualization for the involved persons.

In some examples, the installation or removal path of at least one component, along with information on collisions or near-collisions, is recorded. These paths can be visualized during or after the installation or removal attempt, together with the detected collisions or near-collisions. It is possible to record which objects collided or almost collided, where, and the extent of the collisions. Visualization can include alternative perspectives, such as a side or top view, which are not possible in mixed reality. This enables comprehensive analysis and assessment of the installation or removal attempt.

In some examples, at least one other person is involved in the installation or removal attempt. The involved persons can be together in one location or in different locations, even away from the installation environment. This allows testing the installation of components that require multiple people. For example, one installer can position a component while another fastens it with a tool. Alternatively, decision-makers can be involved via video transmission.

In some examples, at least one involved person is located away from the installation environment. The present disclosure allows interaction with the installation environment by persons not present at its location. These persons can have a different installation environment configuration at their location. Interaction with all virtual elements and real objects at each location is possible. The real objects can include the component to be installed or a tool. This enables cross-location collaboration, even if tools or parts are only present in certain locations

FIG. 1 schematically shows a method for testing an installation or a removal of at least one component within an installation environment. The installation environment has real elements and virtual elements. In a first step, the at least one component, the installation environment together with the real elements, at least one hand of an installer, and a mixed reality system worn by the installer are surveyed 10. The installer may also be located away from the installation environment. The surveying 10 of the hand of the installer preferably encompasses the surveying of a glove worn by the installer and a surveying of the fingers of the hand in relation to the glove. During an attempted installation or removal of the at least one component, a tracking 11 of the at least one component, the hand of the installer, and the mixed reality system is carried out. In the process, the respective position and orientation can be detected and recorded. In addition, at least one tool can be surveyed 10 and tracked 11. The tracking 11 is preferably based on a detection of passive or active markers, or of three-dimensional tracking elements, which are arranged at the or in the components, at the or in the mixed reality system, at or in a tool, or at the hand of the installer. Moreover, collisions or near-collisions between a component, the hand of the installer or a tool, and the real elements and the virtual elements of the installation environment, as well as among the components, are detected 12, and concealments are determined 13. Virtual representatives of real objects are preferably used for this purpose. Tactile, auditory or visual feedback can be provided to the installer in response to a collision or near-collision with a virtual element or a real object. Collisions or near-collisions that occur outside a visual range of the installer can additionally be visualized by means of a notice in the field of view of the installer and/or conveyed auditorily or haptically. The attempted installation or removal of the at least one component is visualized 14 for the installer by the mixed reality system. The determined concealments are taken into consideration in the process. The installation path or removal path of the at least one component is recorded 15. In addition to the installer, at least one additional person can be involved in the attempted installation or removal of the at least one component. This person can be present at the location of the installer or at another location.

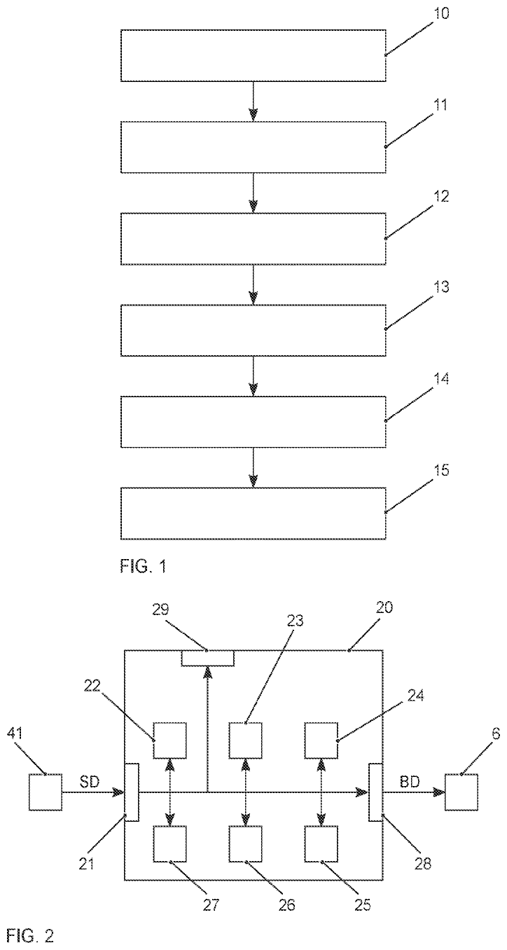

FIG. 2 shows a simplified schematic representation of a first embodiment of a device 20 method for testing an installation or a removal of at least one component within an installation environment. The installation environment has real elements and virtual elements. The device 20 has an input 21, via which data SD can be received from sensors 41. A surveying module 22 is configured to survey the at least one component, the installation environment together with the real elements, at least one hand of an installer, and a mixed reality system 6 worn by the installer based on the received data SD. The installer may also be located away from the installation environment. The surveying of the hand of the installer preferably encompasses the surveying of a glove worn by the installer and a surveying of the fingers of the hand in relation to the glove. A tracking module 23 is configured, during an attempted installation or removal of the at least one component, to carry out a tracking of the at least one component, of the hand of the installer, and of the mixed reality system based on the received data SD. In the process, the respective position and orientation can be detected and recorded. In addition, at least one tool can be surveyed and tracked. The tracking is preferably based on a detection of passive or active markers, or of three-dimensional tracking elements, which are arranged at the or in the components, at or in the mixed reality system, at or in a tool, or at the hand of the installer. An evaluation module 24 is configured to detect collisions or near-collisions between a component, the hand of the installer or a tool, and the real elements and the virtual elements of the installation environment, as well as among the components, and to ascertain concealments. Virtual representatives of real objects are preferably used for this purpose. Tactile, auditory or visual feedback to the installer can be prompted in response to a collision or near-collision with a virtual element or a real object. A visualization module 25 is configured to visualize the attempted installation or removal of the at least one component for the installer by the mixed reality system. For this purpose, the visualization module 25 can output corresponding image data BD via an output 28 of the device 20 to the mixed reality system 6. The visualization module 25 can additionally visualize collisions that occur outside a visual range of the installer and/or convey these auditorily or haptically. In addition to the installer, at least one additional person can be involved in the attempted installation or removal of the at least one component. This person can be present at the location of the installer or at another location.

The surveying module 22, the tracking module 23, the evaluation module 24, and the visualization module 25 can be controlled by a control module 26. Via a user interface 29, settings of the surveying module 22, of the tracking module 23, of the evaluation module 24, of the visualization module 25, or of the control module 26 can be changed, where necessary. The data arising in the device 20 can be saved, if needed, to a memory 27, for example for a later evaluation or for use by the components of the device 20. The surveying module 22, the tracking module 23, the evaluation module 24, the visualization module 25 as well as the control module 26 can be implemented as dedicated hardware, for example as integrated circuits. However, they can, of course, also be partially or completely combined or implemented as software running on a suitable processor, for example on a GPU or a CPU. The input 21 and the output 28 can be implemented as separate interfaces or as one combined bidirectional interface.

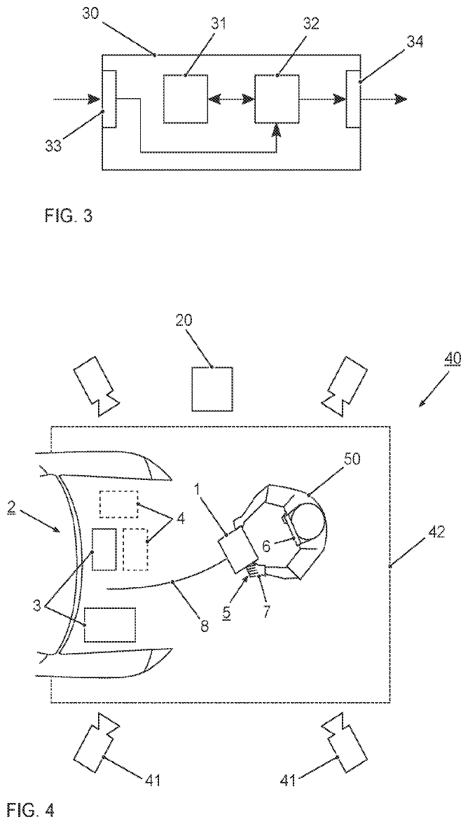

FIG. 3 shows a simplified schematic representation of a second embodiment of a device method for testing an installation or a removal of at least one component within an installation environment. The installation environment has real elements and virtual elements. The device 30 comprises a processor 32 and a memory 31. For example, the device 30 is a computer or a control unit. Instructions are saved in the memory 31, which prompt the device 30, when the instructions are being executed by the processor 32, to carry out the steps according to one of the described methods. The instructions saved in the memory 31 thus embody a program that can be executed by the processor 32 and implements the method according to some aspects of the present disclosure. The device 30 has an input 33 for receiving information. Data generated by the processor 32 is provided via an output 34. Additionally, the data can be saved in the memory 31. The input 33 and the output 34 can be combined to form a bidirectional interface.

The processor 32 can comprise one or more processor units, for example microprocessors, digital signal processors, or combinations thereof.

The memories 27, 31 of the described embodiments can include both volatile and non-volatile memory areas and encompass a wide variety of memory devices and memory media, for example hard disks, optical memory media, or semiconductor memories.

A preferred embodiment of a solution according to some aspects of the present disclosure shall be described hereafter based on FIG. 4 to FIG. 6.

FIG. 4 schematically shows an installation or a removal of at least one component 1 within an installation environment 2. The installation environment 2, which is an engine compartment of a motor vehicle in the present example, comprises a series of real elements 3, illustrated here by the solid lines, and virtual elements 4, illustrated here by the dotted lines. The installation environment 2 is part of a testing system 40. The testing system 40 comprises sensors 41 for the tracking process, for example cameras, which span a tracking area 42. The component 1 is held by an installer 50 using at least one hand 5 and is installed into the installation environment 2, or removed from the installation environment 2, along a path 8 at an intended location. The path 8 can in particular be selected directly by the user, for example based on his or her assessment of the situation. However, the path 8 may also be a predefined path 8 which is known, for example from a technical description of the installation or removal processes. Such a predefined path 8 can also be displayed in the field of view. So as to visualize an attempted installation or removal of the component 1, the installer 50 wears a mixed reality system 6. The component 1, the real elements 3 of the installation environment 2, the hand 5 of the installer 50, and the mixed reality system 6 are surveyed. A device 20, according to some aspects of the present disclosure, uses the data of the sensors 41 to carry out a tracking of all involved objects and to provide image data for the mixed reality system 6. The installer 50 is wearing a glove 7. Using a tracker on the back of the hand, it is determined where the hand 5 is generally located. The fingers of the hand 5 in relation to the glove 7 are likewise surveyed, so that the pose of the fingers can also be tracked. Since the accuracy of the superposition of the virtual and real environments is crucial for an assessment of potential installation examinations, all involved objects are surveyed with high precision and tracked. In particular, camera-based systems can be used for tracking.

Depending on the complexity of the installation environment, concealment may pose a major problem. It may therefore be helpful when the sensors 41 used for tracking comprise additional sensor elements that are integrated into the installation environment. The tracking, however, may also be implemented by a combination of outside-in tracking and inside-out tracking, that is, a sensor fusion of two systems. The outside perspective during outside-in tracking provides a larger field of view, but is also easily limited by the user himself or herself. Even though the intrinsic perspective of the user during inside-out tracking has a smaller field of view or tracking volume and is additionally limited by the hands 5 and the component 1 or a tool that is used, this can be utilized when the outside perspective is not available.

FIG. 5 schematically shows a component 1 having markers 43 arranged thereon. In this case, the markers 43 are passive markers. The markers 43 are glued to the component 1 and arranged at known reference points. As an alternative, the markers 43 can also be printed on or be incorporated during the production of the component 1. The markers 43 are configured so as to be easily detectable by cameras of a tracking system. The markers span a point cloud, which can be compared to a point cloud determined from the camera images. Since there is only one correct assignment of the measured point cloud to the known point cloud spanned by the markers 43, the position and orientation of the component 1 in the space can be computed by a compensating transform. As an alternative to passive markers 43, it is also possible to use active markers. These can, for example, be provided in the form of infrared light-emitting diodes, which can be incorporated into the component 1 or attached to the component 1 together with an energy supply system. The position of the infrared light-emitting diodes can, in turn, be detected by suitable cameras of a tracking system. Another option is the use of three-dimensional tracking elements. These can be, for example, specially shaped parts that are integrated into the component 1 or can be fastened to the component 1, for example by being screwed to existing screw points or screw points provided specifically for this purpose. During an attempted installation or removal, the shape of the component 1 is of importance. It is therefore especially advantageous when the markers 43 are incorporated into the component 1 or attached so as to not decisively change the volume or the outer shape. In this way, a functional technical solution is provided, despite the shape of the component 1 remaining unchanged.

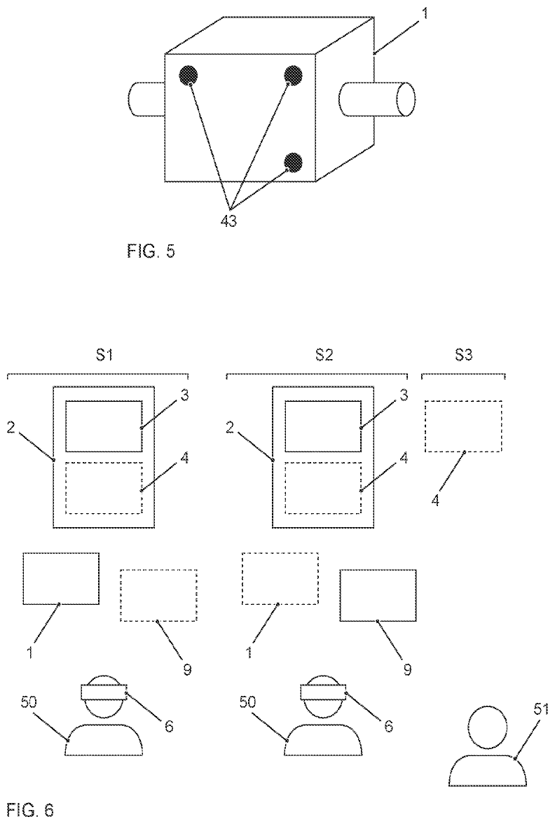

FIG. 6 schematically shows a system diagram of a solution according to some aspects of the present disclosure. In this example, the solution may be implemented across locations. An installation environment 2 including real elements 3, illustrated by the solid lines, and virtual elements 4, illustrated by the dotted lines, is situated at a first location S1. In addition, an installer 50 is present at the first location S1, who is to install a component 1 in an intended position in the installation environment 2, or to remove the component. The installer 50 is wearing a mixed reality system 6. All objects are fully tracked at the first location S1.

The same or a deviating installation environment 2 including real elements 3 and virtual elements 4 is present at a second, remote location S2. In addition, an additional installer 50 is present at the second location, who in this example is directly involved in the installation. The additional installer 50 is likewise wearing a mixed reality system 6 and is operating a tool 9 for installing the component 1. The component 1 is integrated as a virtual object for this purpose at the second location S2, which is illustrated by the dotted lines. Accordingly, the tool 9 at the first location S1 is integrated as a virtual object. All objects are also fully tracked at the second location S2. The real elements 3 and the virtual elements 4 at the different locations S1, S2 are not necessarily the same elements. For example, a brake booster may be present as a real element 3 at the first location S1, which is only present as a virtual element 4 at the second location S2, while the opposite applies, for example, to a steering rod.

The installer 50 at the first location S1 can interact with the real objects on-site, that is, the real elements 3 and the component 1, as well as with all virtual objects, that is, the virtual elements 4 and the tool 9. The additional installer 51 at the second location S2 can likewise interact with the real objects on-site, that is, the real elements 3 and the tool 9, as well as with all virtual objects, that is, the virtual elements 4 and the component 1. The virtual elements 4 can optionally be entirely or partly provided by a third location S3.

Regardless of the location, observers 51 can track the installation or removal. These are able to observe the process from their own perspective or, alternatively, assume the perspective of the installer 50 at the first location S1 or of the additional installer 50 at the second location S2. The observers 51 can preferably interact with all virtual objects.

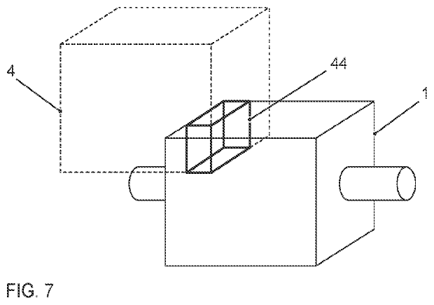

FIG. 7 shows a collision between two objects by way of example. The objects in this case are a component 1 and a virtual element 4 of the installation environment. During the attempted installation, a collision occurs between the component 1 and a virtual element 4 with the selected or predefined installation path. The collision area 44 is visually highlighted and can additionally be recorded. Since the collision occurs with a virtual element 4, a penetration of the objects exists in this case. This is not possible in the case of a collision between real objects. In this case, only near-collisions or boundaries can be represented (not mapped). The collision area 44 then denotes the area of the respective surfaces which is affected by the collision or the near-collision.

### LIST OF REFERENCE SIGNS

1 component
2 installation environment
3 real element 4 virtual element
5 hand
6 mixed reality system
7 glove
8 path
9 tool
10 surveying objects
11 tracking the objects during an attempted installation or removal of at least one component
12 detecting collisions or near-collisions
13 ascertaining concealments
14 visualizing the attempted installation or removal
15 recording the installation path or removal path as well as further relevant data
20 device
21 input
22 surveying module
23 tracking module
24 evaluation module
visualization module
26 control module
27 memory
28 output
29 user interface
30 device
31 memory
32 processor
33 input
34 output
40 testing system
41 sensor
42 tracking area
43 marker
44 collision area
50 installer
51 observer
BD image data
SD sensor data

1-15. (canceled)

16. A method implemented by a computer system for testing an installation or removal of at least one component within an installation environment that includes real and virtual elements, the method comprising:
calibrating, by the computer system, the at least one component, the installation environment with the real elements, at least one hand, and a mixed reality system;
tracking, by the computer system, the at least one component, the hand, and the mixed reality system during an attempted installation or removal of the at least one component; and
visualizing, by the computer system, the attempted installation or removal of the at least one component using the mixed reality system.

17. The method of claim 16, further comprising detecting and recording, by the computer system, the respective position and orientation of the at least one component, the hand, and the mixed reality system during the tracking.

18. The method of claim 16, further comprising calibrating and tracking, by the computer system, at least one tool.

19. The method of claim 16, wherein the tracking is based on detecting, by the computer system, passive or active markers, or three-dimensional tracking elements, which are arranged on or within the components, the mixed reality system, the tool, or the hand.

20. The method of claim 16, wherein calibrating the hand includes calibrating, by the computer system, a glove worn by the hand and the fingers in relation to the glove.

21. The method of claim 16, further comprising detecting, by the computer system, collisions or near-collisions between the component, the hand, or a tool, and the real elements and the virtual elements of the installation environment, as well as among the components, during the attempted installation or removal of the at least one component.

22. The method of claim 21, wherein virtual representations of real objects are used by the computer system to detect or visualize collisions or near-collisions.

23. The method of claim 21, further comprising providing tactile, auditory, or visual feedback, by the computer system, in response to a collision or near-collision with a virtual element or a real object.

24. The method of claim 21, wherein collisions or near-collisions occurring outside the visual range are visualized by providing a notice in the field of view, by the computer system.

25. The method of claim 16, wherein virtual representations of real objects are used by the computer system to determine obstructions that are considered during the visualization of the attempted installation of the at least one component.

26. The method of claim 16, further comprising recording, by the computer system, the installation or removal path of the at least one component and information relating to collisions or near-collisions during the attempted installation or removal.

27. An apparatus for testing an installation or a removal of at least one component within an installation environment that includes real and virtual elements, the apparatus comprising:
a calibration module for calibrating the at least one component, the installation environment with the real elements, at least one hand, and a mixed reality system;
a tracking module for tracking the at least one component, the hand, and the mixed reality system during an attempted installation or removal of the at least one component; and
a visualization module for visualizing the attempted installation or removal of the at least one component using the mixed reality system.

28. The apparatus of claim 27, further comprising a detection module for detecting and recording the respective position and orientation of the at least one component, the hand, and the mixed reality system during the tracking.

29. The apparatus of claim 27, wherein the tracking module is configured to detect passive or active markers, or three-dimensional tracking elements, which are arranged on or within the components, the mixed reality system, a tool, or the hand.

30. The apparatus of claim 27, further comprising a collision detection module for detecting collisions or near-collisions between the component, the hand, or a tool, and the real elements and the virtual elements of the installation environment, as well as among the components, during the attempted installation or removal of the at least one component.

31. The apparatus of claim 30, wherein the collision detection module utilizes virtual representations of real objects to detect or visualize collisions or near-collisions.

32. The apparatus of claim 30, further comprising a feedback module for providing tactile, auditory, or visual feedback in response to a collision or near-collision with a virtual element or a real object.

33. The apparatus of claim 30, wherein the visualization module is configured to visualize collisions or near-collisions occurring outside the visual range by providing a notice in the field of view, or utilizes virtual representations of real objects to determine obstructions that are considered during the visualization of the attempted installation of the at least one component.

34. The apparatus of claim 27, further comprising a recording module for recording the installation or removal path of the at least one component and information relating to collisions or near-collisions during the attempted installation or removal.

35. A computer program product for testing an installation or removal of at least one component within an installation environment that includes real and virtual elements, the computer program product comprising a non-transitory computer-readable medium having program instructions stored thereon, the program instructions executable by a computer system to perform a method comprising:
calibrating, by the computer system, the at least one component, the installation environment with the real elements, at least one hand, and a mixed reality system;
tracking, by the computer system, the at least one component, the hand, and the mixed reality system during an attempted installation or removal of the at least one component; and
visualizing, by the computer system, the attempted installation or removal of the at least one component using the mixed reality system.
